(19) United States
(12) Patent Application Publication
(10) Pub. No.: US 2024/0272854 A1
(43) Pub. Date: Aug. 15, 2024

(54) PHYSIOLOGICAL INFORMATION COLLECTING DEVICE, NON-TRANSITORY COMPUTER-READABLE MEDIUM, AND TERMINAL DEVICE

(71) Applicant: NIHON KOHDEN CORPORATION, Tokyo (JP)

(72) Inventors: Ryo HAYASE, Tokorozawa-shi (JP); Yoshinori ENOMOTO, Tokorozawa-shi (JP); Masamune SATO, Tokorozawa-shi (JP)

(21) Appl. No.: 18/431,383

(22) Filed: Feb. 2, 2024

(30) Foreign Application Priority Data
Feb. 13, 2023 (JP) 2023-020089

(51) Int. Cl. G06F 3/14; G06T 11/20

(52) U.S. Cl. CPC G06F 3/14; G06T 11/206; G06T 2210/41

(57) ABSTRACT

A reception interface is configured to receive physiological information of a subject. A communication interface is configured to allow communication with a terminal device provided with a display. A processor is configured to create data for visualize information including at least the physiological information. The processor is configured to selectively execute either one of: a first communication protocol configured to transmit the data from the communication interface as a reply to a request transmitted from the terminal device; and a second communication protocol configured to transmit the data from the communication interface at a prescribed timing while maintaining connection established by a request transmitted from the terminal device. Information corresponding to the data transmitted by the second communication protocol has a higher priority for requiring an immediate display on the display than the information corresponding to the data transmitted by the first communication protocol.

### CROSS-REFERENCE TO RELATED APPLICATION

The present application is based on Japanese Patent Application No. 2023-020089 filed on Feb. 13, 2023, the entire contents of which are incorporated herein by reference.

### BACKGROUND

The presently disclosed subject matter relates to a physiological information collecting device configured to collect physiological information of a subject. The presently disclosed subject matter also relates to a non-transitory computer-readable medium having stored a computer program adapted to be executed by a processor installed in the physiological information collecting device. The presently disclosed subject matter also relates to a terminal device adapted to communicate with the physiological information collecting device, as well as a non-transitory computer-readable medium having stored a computer program adapted to be executed by a processor installed in the terminal device.

Japanese Patent Publication No. 2020-178917A discloses a configuration in which a web server function is installed in an electrocardiograph. A web server function is installed in an external device adapted to communicate with the electrocardiograph. The electrocardiograph creates a data file that enables observation of electrocardiogram waveforms in response to a request from the external device, and transmits the data file to the external device located in a remote place. In the external device, the electrocardiogram waveforms can be observed with the web browser function.

### SUMMARY

It is demanded to enhance flexibility as for the observation of physiological information in a remote place.

A first illustrative aspect of the presently disclosed subject matter provides a physiological information collecting device, comprising:
a reception interface configured to receive physiological information of a subject;
a communication interface configured to allow communication with a terminal device provided with a display; and
a processor configured to create data for visualize information including at least the physiological information,
wherein the processor is configured to selectively execute either one of:
   a first communication protocol configured to transmit the data from the communication interface as a reply to a request transmitted from the terminal device; and
   a second communication protocol configured to transmit the data from the communication interface at a prescribed timing while maintaining connection established by a request transmitted from the terminal device; and
wherein information corresponding to the data transmitted by the second communication protocol has a higher priority for requiring an immediate display on the display than the information corresponding to the data transmitted by the first communication protocol.

A second illustrative aspect of the presently disclosed subject matter provides a non-transitory computer-readable medium having stored a computer program adapted to be executed by a processor installed in a physiological information collecting device, the computer program being configured, when executed, to cause the physiological information collecting device to:
receive physiological information of a subject; and
create data for visualize information including at least the physiological information;
execute selectively either one of a first communication protocol or a second communication protocol;
wherein, in the first communication protocol, the data is transmitted as a reply to a request transmitted from the terminal device;
wherein, in the second communication protocol, the data is transmitted at a prescribed timing while maintaining connection established by a request transmitted from the terminal device; and
wherein information corresponding to the data transmitted by the second communication protocol has a higher priority for requiring an immediate display on the display than the information corresponding to the data transmitted by the first communication protocol.

According to the configuration of each of the first and second illustrative aspects, since voluntary data transmission from the physiological information collecting device to the terminal device is allowed, a user of the terminal device can observe the physiological information of the subject that is collected by the physiological information collecting device, along with high immediacy even if the user is in a place remote from the physiological information collecting device. Since the observation is performed with the web browser function that is pre-installed in the terminal device, it is not necessary to prepare an exclusive device or equipment in order to provide such an immediate observation environment.

Accordingly, the flexibility as for the observation of the physiological information in the remote place can be enhanced.

A third illustrative aspect of the presently disclosed subject matter provides a non-transitory computer-readable medium having stored a computer program adapted to be executed by a processor installed in a terminal device adapted to communicate with a physiological information collecting device configured to collect physiological information of a subject, the computer program being configured, when executed, to cause the terminal device to:
receive data corresponding to the physiological information; and
visualize, based on the data, at least a part of the physiological information on a screen of a web browser displayed on a display;
wherein the physiological information includes first information in which a display aspect ratio is fixed and second information in which the display aspect ratio is not fixed; and
wherein the terminal device is configured to change, based on an amount of the physiological information corresponding to the data and a size of the screen of the web browser, at least one of: a ratio of an area of a region in the screen of the web browser in which the first information is to be visualized and an area of a region in the screen of the web browser in which the second information is to be visualized; an amount of the first information to be visualized; and an amount of the second information to be visualized, while maintaining a scale of the display aspect ratio of the first information that is to be visualized.

A fourth illustrative aspect of the presently disclosed subject matter provides a terminal device adapted to communicate with a physiological information collecting device configured to collect physiological information of a subject, comprising:
a communication interface configured to receive data corresponding to the physiological information; and
a processor configured to visualize, based on the data, at least a part of the physiological information on a screen of a web browser displayed on a display,
wherein the physiological information includes first information in which a display aspect ratio is fixed and second information in which the display aspect ratio is not fixed; and
wherein the processor is configured to change, based on an amount of the physiological information corresponding to the data and a size of the screen of the web browser, at least one of: a ratio of an area of a region in the screen of the web browser in which the first information is to be visualized and an area of a region in the screen of the web browser in which the second information is to be visualized; an amount of the first information to be visualized; and an amount of the second information to be visualized, while maintaining a scale of the display aspect ratio of the first information that is to be visualized.

The web browser application that is executed on the terminal device can freely change the size of the screen on which information is visualized on the display included in the terminal device. According to the configuration of each of the third and fourth illustrative aspects, the physiological information that is provided from the physiological information collecting device is classified into the first information and the second information in accordance with whether the display aspect ratio is determined, and is subjected to one of the individual display controls. For example, adjustment may be performed with consideration of the visibility with respect to an area of the region in which each information item is visualized, and/or an amount of information that is to be visualized in the region. With respect to the first information in which the display aspect ratio is determined as in the vital sign waveform of the subject, the display aspect ratio is maintained regardless of the size of the screen of the web browser. Accordingly, a change of the size of the screen hardly affects the determination based on the first information. As a result, since the terminal device can provide an observation environment in which the dependency on the specification of the physiological information collecting device is reduced, the flexibility as for the observation of the physiological information in the remote place can be enhanced.

### DESCRIPTION OF THE DRAWINGS

FIG. 1 illustrates a functional configuration of a physiological information observing system according to one exemplary embodiment.

FIG. 2 illustrates an exemplary configuration of the physiological information observing system of FIG. 1.

FIG. 3 illustrates an exemplary flow of processing in a case where a WebSocket protocol is executed in a physiological information collecting device of FIG. 1.

FIG. 4 illustrates an exemplary screen displayed on a display of a terminal device of FIG. 1.

FIG. 5 illustrates another exemplary screen displayed on a display of a terminal device of FIG. 1.

FIG. 6 illustrates an exemplary flow of display control processing executed by the terminal device of FIG. 1.

FIG. 7 illustrates another exemplary screen displayed on a display of a terminal device of FIG. 1.

FIG. 8 illustrates another exemplary screen displayed on a display of a terminal device of FIG. 1.

FIG. 9 illustrates another exemplary screen displayed on a display of a terminal device of FIG. 1.

FIG. 10 illustrates another exemplary screen displayed on a display of a terminal device of FIG. 1.

FIG. 11 illustrates an example of the terminal device of FIG. 1.

FIG. 12 illustrates another example of the terminal device of FIG. 1.

FIG. 13 illustrates another example of the terminal device of FIG. 1.

### DESCRIPTION OF EMBODIMENTS

Exemplary embodiments will be described in detail with reference to the accompanying drawings.

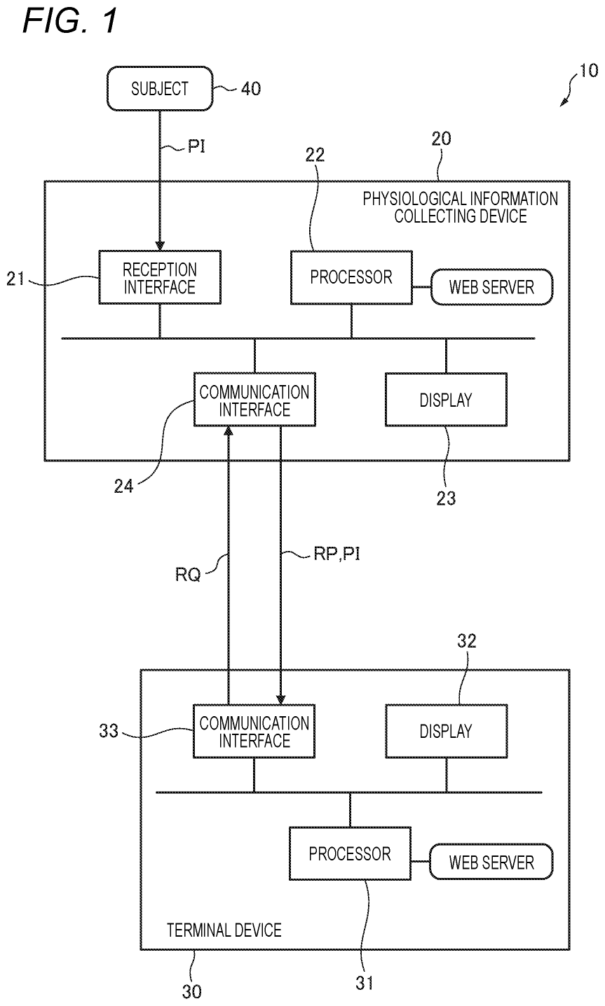

FIG. 1 illustrates a functional configuration of a physiological information observing system 10 according to an exemplary embodiment. The physiological information observing system 10 includes a physiological information collecting device 20 and a terminal device 30. The physiological information collecting device 20 is a device is configured to collect physiological information PI of a subject 40. The terminal device 30 is adapted to communicate with the physiological information collecting device 20. The way of communication may be wired communication or wireless communication. The terminal device 30 includes a display 32. The physiological information observing system 10 is configured to enable a user to observe at least the physiological information PI of the subject 40 that is collected by the physiological information collecting device 20, with the display 32 of the terminal device 30.

The physiological information collecting device 20 includes a reception interface 21. The reception interface 21 is a hardware interface that receives the physiological information PI of the subject 40. The physiological information PI includes at least a vital sign of the subject 40. As used herein, the term “vital sign” means a numerical value of at least one of a pulse rate, a pulse wave, a blood oxygen saturation, a respiration rate, a respiration curve, a carbon dioxide partial pressure curve, a terminal expired carbon dioxide partial pressure (ETCO2), a body temperature, a blood pressure, an electrocardiogram (the number of VPCs, an ST level, a QTc/QRSd), and a level of consciousness, or a change with time of the numerical value. The change with time of the numerical value can be visualized as a waveform or a graph.

The physiological information PI may be directly collected with a device such as a sensor attached to the subject 40, or may be indirectly collected through another device that is interposed between the subject 40 and the physiological information collecting device 20.

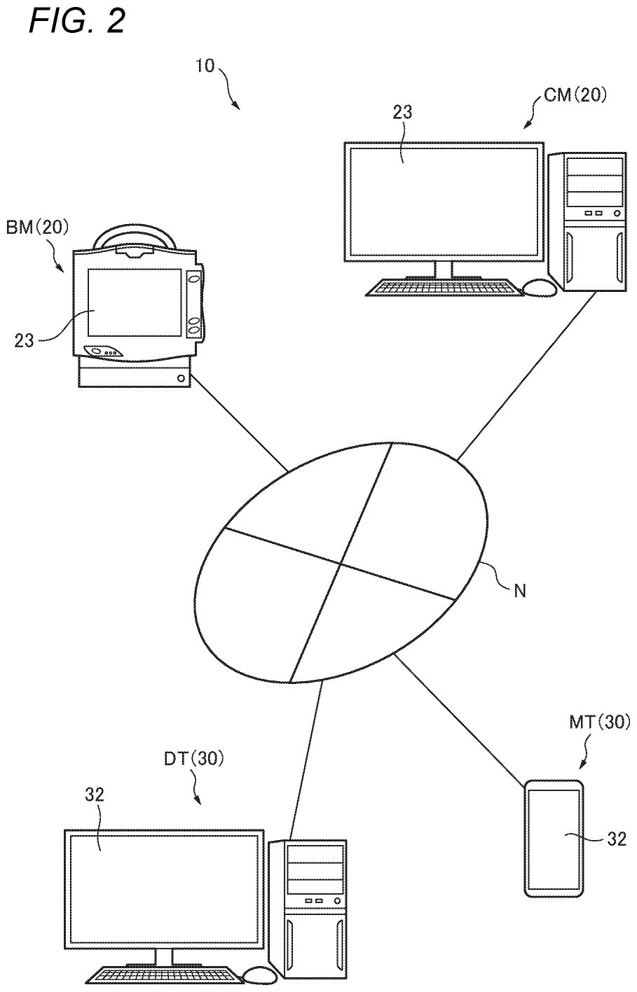

FIG. 2 illustrates an exemplary physiological information observing system 10. In this example, a bedside monitor BM, a central monitor CM, a desktop terminal DT, and a mobile terminal MT are connected to a communication network N.

The bedside monitor BM is a device adapted to be disposed in the vicinity of the subject to collect the physiological information PI with a device such as a sensor that is attached to the subject 40. The bedside monitor BM is an example of the physiological information collecting device 20. Although not illustrated, a medical telemeter configured to receive the physiological information PI that is collected by a sensor attached to a subject 40 at a remote place and is wirelessly transmitted may also be an example of the physiological information collecting device 20.

The central monitor CM is a device that is disposed in a nurse station or the like, and configured to comprehensively manage the physiological information PI of multiple subjects 40 that are collected by multiple bedside monitors BM. The central monitor CM may also be an example of the physiological information collecting device 20.

The desktop terminal DT is a stationary device that is disposed in a place remote from the bedside monitor BM and the central monitor CM. The desktop terminal DT is adapted to communicate with at least one of the bedside monitor BM and the central monitor CM through the communication network N. The desktop terminal DT is an example of the terminal device 30. The desktop terminal DT includes a display 32 having a relatively large display area.

The mobile terminal MT is a device adapted to be carried by a user. The mobile terminal MT is adapted to communicate with at least one of the bedside monitor BM and the central monitor CM through the communication network N. The mobile terminal MT is an example of the terminal device 30. The mobile terminal MT comprises a display 32 having a relatively small display area.

The physiological information PI may be in the form of analog data or digital data, in accordance with the specification of the device on the transmission side. In a case where the physiological information PI is in the form of analog data, the reception interface 21 is provided with an adequate conversion circuit including an A/D converter.

The physiological information collecting device 20 includes a processor 22 and a display 23. The processor 22 is configured to display, on the display 23, information in which the physiological information PI received by the reception interface 21 is visualized in the form of numerical value or waveform. The user can visually confirm the physiological information PI of the subject 40 with the display 23.

The terminal device 30 includes a processor 31. The processor 31 is configured to display various kinds of information on the display 32. The user can visually confirm various kinds of information with the display 32.

The physiological information collecting device 20 includes a communication interface 24. The terminal device 30 includes a communication interface 33. The communication interface 24 and the communication interface 33 are configured to enable bidirectional communication of data in compliance with a prescribed standard.

The processor 31 of the terminal device 30 is adapted to activate a web browser. Upon the activation of the web browser, the terminal device 30 requests the web server that manages a web page designated by the user to transmit data, so that the transmitted data can be displayed on the display 32 with a designated layout.

In the present exemplary embodiment, a data transmission request RQ is transmitted from the communication interface 33 of the terminal device 30 to the communication interface 24 of the physiological information collecting device 20. In response to the reception of the data transmission request RQ, the processor 22 of the physiological information collecting device 20 is configured to transmit the requested data as a reply RP. The reply RP is transmitted from the communication interface 24 of the physiological information collecting device 20 to the communication interface 33 of the terminal device 30. The data received by the communication interface 33 of the terminal device 30 are subjected to visualization on the display 32.

In other words, the processor 22 of the physiological information collecting device 20 may operate as a web server. The processor 22 performs the above-described data communication based on HTTP (Hyper Text Transfer Protocol). The HTTP is an example of a first communication protocol.

The processor 22 is configured to execute a WebSocket protocol as well. The WebSocket protocol is used for transmitting the physiological information PI received by the reception interface 21 from the communication interface 24 to the terminal device 30 while maintaining the connection established by the HTTP. The WebSocket protocol is an example of a second communication protocol.

With the execution of the WebSocket protocol, it is possible to perform voluntary data transmission even from the side of the physiological information collecting device 20, while maintaining the connection established by the HTTP. The information corresponding to the data includes at least the physiological information PI of the subject 40. For example, each time the reception interface 21 receives the physiological information PI, the processor 22 creates data for visualizing the physiological information PI on the display 32 of the terminal device 30, and transmits the data from the communication interface 24. “Every time the reception interface 21 receives the physiological information PI” is an example of a prescribed timing.

In the present exemplary embodiment, in order to enable the WebSocket protocol to be executed, Node.js is used as the web server application, Express is used as the framework, and JavaScript is used as the development language. As the library of JavaScript, Socket.io is used.

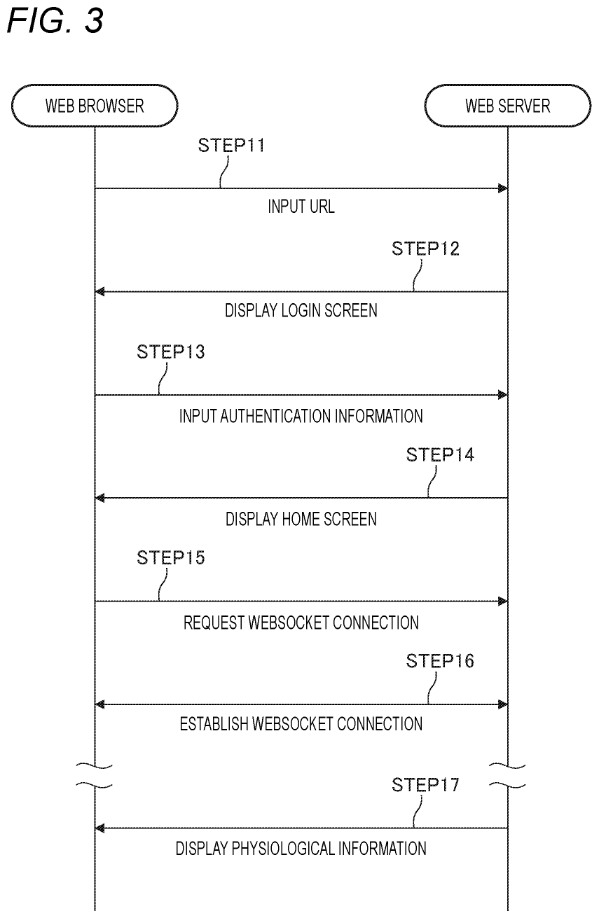

An exemplary flow of processing performed when the processor 22 executes the WebSocket protocol will be described with reference to FIG. 3.

First, the web browser is activated in the terminal device 30, and data specifying a URL (Uniform Resource Locator) is transmitted from the communication interface 33 (STEP 11). The URL designates a web page that is managed by the physiological information collecting device 20. The data specifying the URL is an example of a request transmitted from the terminal device.

When the data specifying the URL is received by the communication interface 24 of the physiological information collecting device 20, the processor 22 transmits, from the communication interface 24, data for causing the display 32 of the terminal device 30 to display a login screen (STEP 12). The data includes an HTML (Hyper Text Markup Language) file, a style sheet (CSS: Cascading Style Sheets), a script (JavaScript), an image, sound, or the like that are used to configure the login screen.

Subsequently, the user inputs authentication information for authenticating the user to the login screen displayed on the display 32 of the terminal device 30. The authentication information includes a login ID, a password, or the like. The inputted authentication information is transmitted from the communication interface 33 of the terminal device 30 (STEP 13).

In response to reception of the authentication information by the communication interface 24 of the physiological information collecting device 20, the processor 22 performs authentication processing of the user. Specifically, it is determined whether the inputted authentication information matches with the authentication information stored in a storage area (not illustrated). In a case where they are matched, the authentication processing is approved. Upon the approval of the authentication processing, the processor 22 transmits, from the communication interface 24, data for causing the display 32 of the terminal device 30 to display a home screen (STEP 14). The data includes an HTML file, a style sheet, a script, an image, and sound that are used to configure the home screen. The home screen is configured to enable reception of an observation request for the physiological information PI of the subject 40.

It should be noted that, if not particularly required, the display of the login screen (STEP 12) and the input of the authentication information (STEP 13) may be omitted. In this case, the home screen is immediately displayed (STEP 14). The processing from STEP 11 to STEP 14 is performed based on the HTTP.

A user who wishes to observe the physiological information PI of the subject 40 on the web browser inputs an observation request to the home screen displayed on the display 32 of the terminal device 30. In response to the input of the observation request, the processor 31 of the terminal device 30 outputs, from the communication interface 33, connection request data for requesting the WebSocket connection (STEP 15). Specifically, the connection request data is transmitted by using an Upgrade header of the HTTP. The connection request data is an example of a request transmitted from the terminal device.

In response to the reception of the connection request data by the communication interface 24 of the physiological information collecting device 20, the processor 22 transmits, from the communication interface 24, a reply acknowledging the request. Specifically, a status code 101 “Switching Protocols” is transmitted. As a result, a WebSocket connection is established between the physiological information collecting device 20 and the terminal device 30 (STEP 16). Thereafter, voluntary data transmission from the physiological information collecting device 20 is allowed (STEP 17).

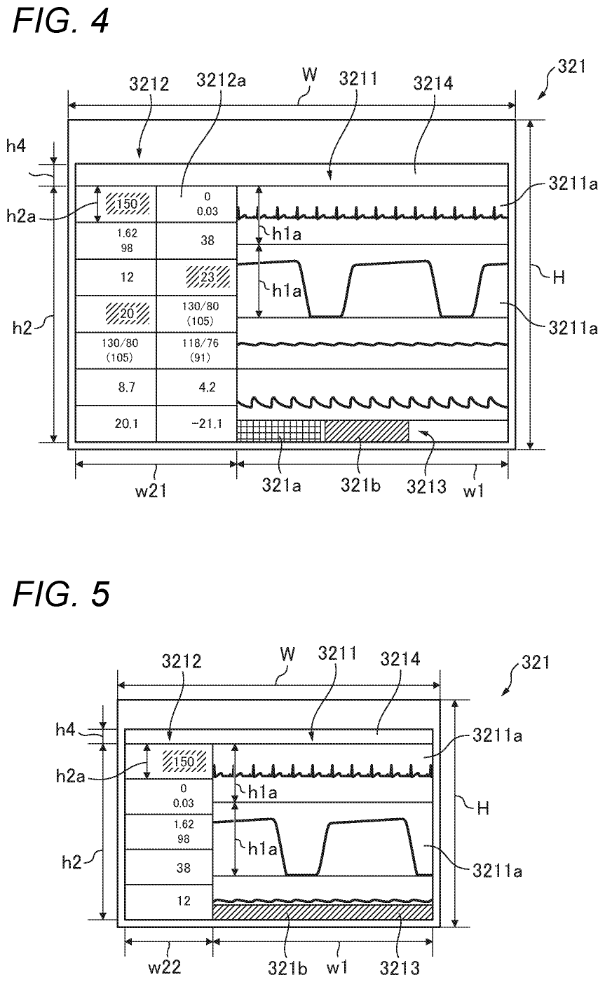

FIG. 4 illustrates a screen 321 of the web browser that is displayed on the display 32 of the terminal device 30. An image indicating the physiological information PI that includes at least a vital sign of the subject 40 is displayed on the screen 321. The image corresponds to an image that is displayed on the display 23 of the physiological information collecting device 20 with which the terminal device 30 establishes the WebSocket connection.

In the present exemplary embodiment, each time the reception interface 21 of the physiological information collecting device 20 receives the physiological information PI of the subject 40, voluntary data transmission from the physiological information collecting device 20 to the terminal device 30 is allowed, whereby the screen 321 of the web browser that is displayed on the display 32 of the terminal device 30 changes in synchronization with the screen that is displayed on the display 23 of the physiological information collecting device 20.

Accordingly, a user of the terminal device 30 can observe the physiological information PI of the subject 40 that is displayed on the display 23 of the physiological information collecting device 20 while being in a place that is remote from the physiological information collecting device 20, along with a high degree of immediacy. Since the observation is performed with the web browser function that is pre-installed in the terminal device 30, it is not necessary to prepare an exclusive device or equipment in order to provide such an immediate observation environment. Accordingly, the flexibility as for the observation of the physiological information PI in the remote place can be enhanced.

As illustrated in FIG. 4, the screen 321 of the web browser may include alarm information 321a for notifying of an abnormality. The abnormality notified by the alarm information 321a may include not only an abnormality that occurs in the vital sign of the subject 40, but also an abnormality that occurs in the collection environment of the physiological information. Examples of the abnormality that occurs in the collection environment of the physiological information include displacement or dropping of a sensor attached to the subject 40, a failure that occurs in the sensor or the physiological information collecting device 20, or the like.

In this case, the user of the terminal device 30 who is in a place that is remote from the physiological information collecting device 20 can receive a notification of a state where at least one of the subject 40 and the physiological information collecting device 20 needs to be confirmed, and can observe the physiological information PI of the subject 40 which is the basis of the notification, along with a high immediacy.

It should be noted that, as long as the WebSocket connection is established between the physiological information collecting device 20 and the terminal device 30, the physiological information PI of the subject 40 may not be always displayed on the display 32 of the terminal device 30.

As an example, in a case where an abnormality is detected in the physiological information collecting device 20, data for visualizing the physiological information PI of the subject 40 on the display 32 together with the alarm information 321a may be transmitted from the physiological information collecting device 20. “A case where an abnormality is detected in the physiological information collecting device 20” is an example of a prescribed timing.

As another example, the user of the terminal device 30 may transmit an observation request with the web browser when the user wishes to observe the physiological information PI of the subject 40. In a case where an observation request for the physiological information PI of the subject 40 is received from the terminal device 30, the physiological information collecting device 20 may transmit data for immediately visualizing the physiological information PI on the display 32 in response to the request. “A case where an observation request for the physiological information PI of the subject 40 is received from the terminal device 30” is an example of the prescribed timing.

As long as the situation where the data is transmitted from the physiological information collecting device 20 to the terminal device 30 at the prescribed timing can be reproduced or simulated, the WebSocket connection may not be used. A processing technique such as Comet or the long polling in the HTTP may also be an example of the second protocol.

The processor 22 of the physiological information collecting device 20 having various functions described above may be implemented by at least one non-exclusive microprocessor that cooperates with a non-exclusive memory. Examples of the non-exclusive microprocessor include a CPU, an MPU, and a GPU. Examples of the non-exclusive memory include a ROM and a RAM. In this case, a computer program that implements the various functions described above may be stored in the ROM. The ROM is an example of a non-transitory computer-readable medium having stored a computer program. The non-exclusive microprocessor designates at least a part of the program stored in the ROM, loads the designated program in the RAM, and executes the above-described processing in cooperation with the RAM. The computer program may be pre-installed in a non-exclusive memory, or may be downloaded from an external server device with a communication network, and then installed in the non-exclusive memory. In this case, the external server device is an example of the non-transitory computer-readable medium having stored the computer program.

The processor 22 may be implemented by at least one exclusive integrated circuitry capable of executing the above-described computer program, such as a microcontroller, an ASIC, and an FPGA. In this case, the above-described computer program is pre-installed in a memory element included in the exclusive integrated circuitry. The memory element is an example of the non-transitory computer-readable medium having stored the computer program. The processor 22 may also be implemented by a combination of the non-exclusive microprocessor and the exclusive integrated circuitry.

Next, display control processing of the display 32 that is executed by the processor 31 of the terminal device 30 will be described with reference to FIGS. 4 and 5. This processing is executed regardless of the type of the protocol used by the processor 22 of the physiological information collecting device 20 for the data transmission.

The information that is visualized on the display 32 includes first information in which a display aspect ratio is fixed, and second information in which the display aspect ratio is not fixed. As used herein, the term “display aspect ratio” means a ratio of the width dimension and the height dimension of a region in which information provided from the physiological information collecting device 20 is visualized. Examples of the first information include a vital sign waveform of the subject 40. Examples of the second information include a vital sign numerical value of the subject 40, attribute information of the subject 40, and alarm information, or the like.

The screen 321 of the web browser includes a first region 3211. In the first region 3211, multiple waveform displaying regions 3211a are arrayed side by side in the vertical direction. In each of the waveform displaying regions 3211a, at least the vital sign waveform of the subject 40 is visualized. The order that the multiple vital sign waveforms are arrayed in the first region 3211 matches with the order that the multiple vital sign waveforms are arrayed in the display 23 of the physiological information collecting device 20.

The screen 321 of the web browser includes a second region 3212. The second region 3212 is disposed on the left side of the first region 3211. In the second region 3212, multiple numerical value displaying regions 3212a are arrayed side by side in the vertical direction. In each numerical value displaying region 3212a, at least the vital sign numerical value of the subject 40 is visualized. The order that the multiple vital sign numerical values are arrayed in the second region 3212 matches with the order that the multiple vital sign numerical values are arrayed in the display 23 of the physiological information collecting device 20. It should be noted that multiple kinds of vital sign numerical values may be visualized in a single numerical value displaying region 3212a.

The screen 321 of the web browser includes a third region 3213. The third region 3213 is disposed below the first region 3211. In the third region 3213, alarm information is visualized.

The screen 321 of the web browser includes a fourth region 3214. The fourth region 3214 is disposed above the first region 3211, the second region 3212, and the third region 3213. The fourth region 3214 is a region for providing a user interface to be for setting, menu display, or the like.

The web browser application that is executed in the terminal device 30 is adapted to change the size of the screen 321 of the web browser on the display 32. The processor 31 performs display control for changing the width dimension of the second region 3212 in accordance with the width dimension W of the screen 321 of the web browser.

As illustrated in FIG. 4, in a case where the width dimension W of the screen 321 of the web browser is no less than a prescribed value, the width dimension of the second region 3212 has a first value w21. The prescribed value is, for example, 800 pixels. The first value w21 is, for example, 400 pixels. The width w1 of the first region 3211 at this time is determined as a value (W−w21) that is obtained by subtracting the first value w21 from the width W of the screen 321.

As illustrated in FIG. 5, in a case where the width dimension of the screen 321 of the web browser is less than the prescribed value, the width dimension of the second region 3212 has a second value w22 that is less than the first value w21. The second value w22 is, for example, 200 pixels. The width w1 of the first region 3211 at this time is determined as a value (W−w22) that is obtained by subtracting the second value w22 from the width W of the screen 321.

The processor 31 performs display control so as to maintain a ratio of the height dimension h2 of the second region 3212 and the height dimension h4 of the fourth region 3214 regardless of the size of the screen 321 of the web browser. For example, the ration is fixed such that h2: h4=95%: 5%.

In the first region 3211, an upper limit value of the height dimension h1a of each waveform displaying region 3211a is determined in advance. For example, the upper limit value may be set to 200 pixels.

When the screen 321 of the web browser is reduced as illustrated in FIG. 5, the region of the first region 3211 is decreased as well. The processor 31 decreases the height dimension h1a of each waveform displaying region 3211a in accordance with the height dimension H of the screen 321. On the other hand, the processor 31 maintains a physical quantity per unit length in the height direction of the vital sign waveform that is visualized in each of the waveform displaying regions 3211a. In other words, the scale of the vital sign waveform in the height direction is not changed.

The width dimension w1 of the first region 3211 is determined as a value that is obtained by subtracting the width dimension (w21 or w22) of the second region 3212 from the width dimension W of the screen 321, as described above. Regardless of the determined value of the width dimension w1, the processor 31 maintains a time period per unit length in the width direction of the vital sign waveform that is visualized in each of the waveform displaying regions 3211a. In other words, the scale of the vital sign waveform in the width direction is not changed. In a case where the vital sign waveform corresponding to 10 seconds is visualized in the first region 3211 illustrated in FIG. 4, the reduced vital sign waveform corresponding to 10 seconds is not visualized in the first region 3211 illustrated in FIG. 5, but the vital sign waveform corresponding to 6 seconds is visualized.

As a result, the number of waveform displaying regions 3211a included in the first region 3211, and the time length of the vital sign waveform that is visualized in each waveform displaying region 3211a are changed while the display aspect ratio of the vital sign waveform as visualized is maintained. In the example illustrated in FIG. 4, the first region 3211 includes four waveform displaying regions 3211a. In the example illustrated in FIG. 5, the number of waveform displaying regions 3211a included in the first region 3211 is decreased to three.

Although not illustrated, the web browser application includes a graphic user interface (GUI) that scrolls a region that is to be visualized in the screen 321 in the height direction and the width direction. The user of the terminal device 30 can visualize a desired portion of the desired vital sign waveform in the first region 3211 by inputting an adequate scroll operation to the GUI.

The processor 31 is configured to change the number and size of the numerical value displaying regions 3212a included in the second region 3212 in accordance with the size of the screen 321.

In a case where the width dimension of the second region 3212 has the first value w21 as illustrated in FIG. 4, the processor 31 causes the second region 3212 to display the two columns of numerical value displaying regions 3212a. In this example, seven numerical value displaying regions 3212a are included in each column.

In a case where the width dimension of the second region 3212 has the second value w22 as illustrated in FIG. 5, the processor 31 causes the second region 3212 to display a row of numerical value displaying regions 3212a. In this example, four numerical value displaying regions 3212a are displayed. The numerical value displaying region 3212a displayed in the uppermost line in the two-column display is sequentially subjected to the arrangement in the single-column display. The numerical value displaying region 3212a that is not accommodated in the second region 3212 is subjected to the visualization with the above-described scroll operation.

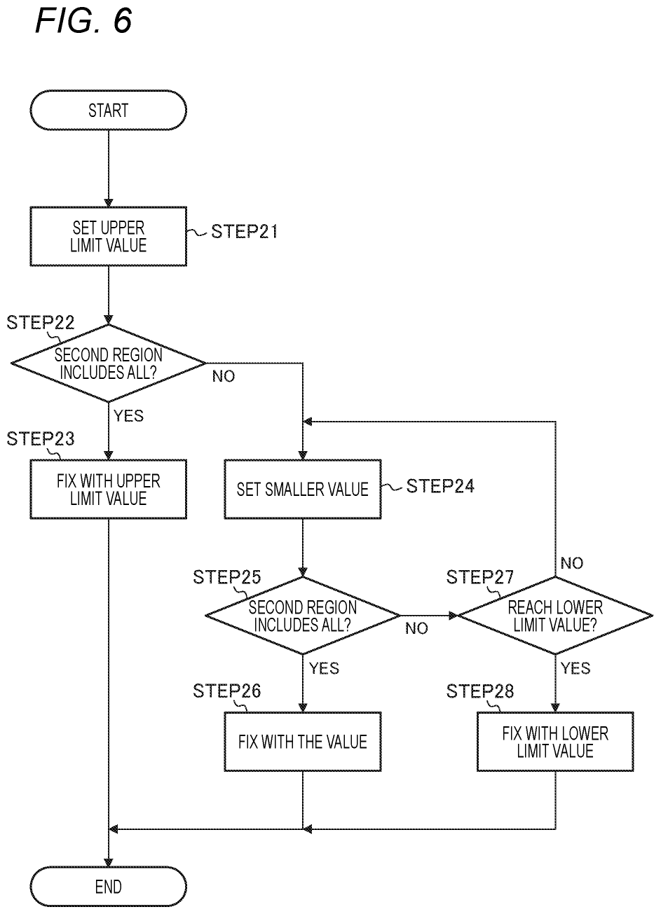

The height dimension h2a of each numerical value displaying region 3212a is made variable between a prescribed upper limit value and a prescribed lower limit value. The upper limit value is, for example, 160 pixels. The lower limit value is, for example, 80 pixels. The processing performed by the processor 31 to determine the height dimension h2a will be described with reference to FIG. 6.

First, in STEP 21, the processor 31 sets the height dimension h2a as the upper limit value. Subsequently, in STEP 22, the processor 31 determines whether all the numerical value displaying regions 3212a in which the height dimension h2a is set to the upper limit value are accommodated in the second region 3212.

In a case where it is determined that all the numerical value displaying regions 3212a in which the height dimension h2a is set to the upper limit value are accommodated in the second region 3212 (YES in STEP 22), the processor 31 fixes the height dimension h2 to the upper limit value, and visualizes all the numerical value displaying regions 3212a in the second region 3212 (STEP 23).

In a case where it is determined that all the numerical value displaying regions 3212a in which the height dimension h2a is set to the upper limit value are not accommodated in the second region 3212 (NO in STEP 22), the processor 31 sets the height dimension h2a to a smaller value (STEP 24). Subsequently, the processor 31 determines whether all the numerical value displaying regions 3212a in which the height dimension h2a is set to the smaller value are accommodated in the second region 3212 (STEP 25).

In a case where it is determined that all the numerical value displaying regions 3212a in which the height dimension h2a is set to the smaller value are accommodated in the second region 3212 (YES in STEP 25), the processor 31 fixes the height dimension h2 to the value, and visualizes all the numerical value displaying regions 3212a in the second region 3212 (STEP 26).

In a case where it is determined that all the numerical value displaying regions 3212a in which the height dimension h2a is set to the smaller value are not accommodated in the second region 3212 (NO in STEP 25), the processor 31 determines whether the set value of the height dimension h2a reaches the lower limit value (STEP 27).

In a case where it is determined that the set value of the height dimension h2a does not reach the lower limit value (NO in STEP 27), the processing returns to STEP 24, and a further smaller value is set to the height dimension h2a. In a case where it is determined that the set value of the height dimension h2a reaches the lower limit value (YES in STEP 27), the processor 31 fixes the height dimension h2 to the lower limit value, and visualizes as many numerical value displaying regions 3212a as the number that can be accommodated in the second region 3212 (STEP 28).

In other words, the processor 31 of the terminal device 30 is configured to change, based on the amount of the physiological information PI corresponding to the data transmitted from the physiological information collecting device 20 and the size of the screen 321 of the web browser, at least one of: the ratio of the areas of the first region 3211 and the second region 3212 in the screen 321 of the web browser; the amount of information that is visualized in the first region 3211; and the amount of information that is visualized in the second region 3212, while maintaining the scale of the first information that is to be visualized.

The web browser application that is executed on the terminal device 30 can freely change the size of the screen 321 on which the information is visualized on the display 32.

According to the above configuration, the physiological information PI that is provided from the physiological information collecting device 20 is classified into the first information and the second information in accordance with whether the display aspect ratio is fixed, and is subjected to one of the individual display controls. For example, adjustment may be performed with consideration of the visibility with respect to an area of the region in which each information item is visualized, and/or an amount of information that is to be visualized in the region. With respect to the first information in which the display aspect ratio is fixed as in the vital sign waveform of the subject 40, the display aspect ratio is maintained regardless of the size of the screen 321 of the web browser. Accordingly, a change of the size of the screen 321 hardly affects the determination based on the first information. As a result, since the terminal device 30 can provide an observation environment in which the dependency on the specification of the physiological information collecting device 20 is reduced, the flexibility as for the observation of the physiological information in the remote place can be enhanced.

The processor 31 is configured to change the alarm information that is visualized in the third region 3213 in accordance with the priority of the alarm information and the size of the screen 321.

The priorities of the alarm information may differ from each other. For example, the priority of the alarm information may be classified into three levels: emergency (urgent response to a medical worker is requested); alert (caution to a medical worker is requested); and attention (notification of a state where an immediate response is not necessary, but the state is not normal). The priority of the “alert” level is lower than the priority of the “emergency” level, and higher than the priority of the “attention” level. In the example illustrated in FIG. 4, the priority of the alarm information 321b is higher than the priority of the alarm information 321a.

When the size of the screen 321 of the web browser is changed, the processor 31 determines whether all the alarm information items are accommodated in the third region 3213. In a case where it is determined that all the alarm information items are accommodated in the third region 3213, the processor 31 visualizes the alarm information item to which the higher priority is assigned in the third region 3213. In the example illustrated in FIG. 5, only the alarm information 321b to which the higher priority is assigned is visualized. The alarm information item 321a that is not accommodated in the third region 3213 is subjected to the visualization with the above-described scroll operation.

According to the above configuration, a change of the size of the screen 321 of the web browser hardly affects the notification capability of the alarm information.

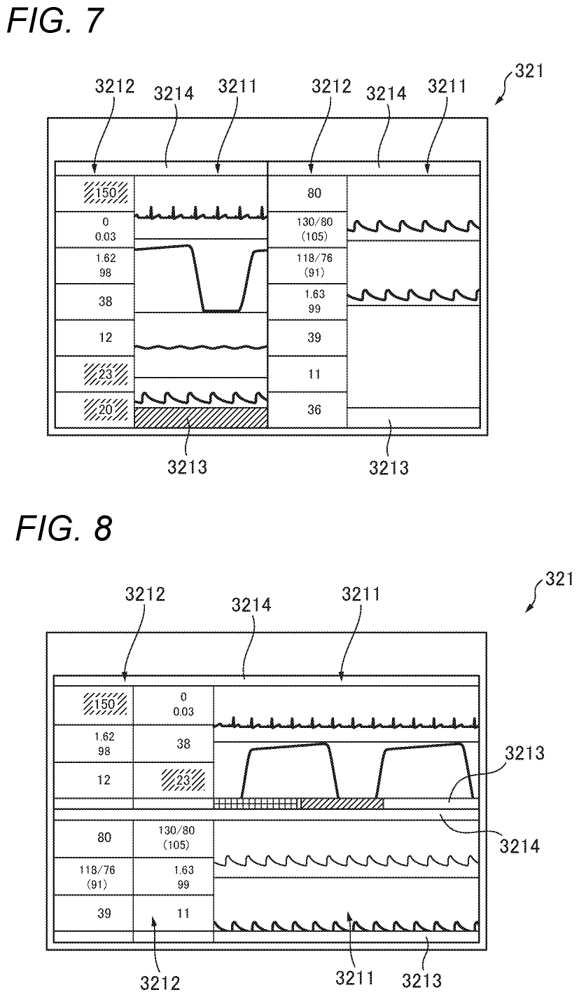

As illustrated in FIGS. 7 and 8, the physiological information PI collected from multiple subjects may be simultaneously visualized in the screen 321 of the web browser. In the example illustrated in FIG. 7, vertically-elongated displaying regions that are created for respective subjects are visualized and arranged side by side in the lateral direction. In the example illustrated in FIG. 8, laterally-elongated displaying regions that are created for respective subjects are visualized and arranged side by side in the vertical direction. The layout of the displaying regions and the number of subjects may be arbitrarily determined within a range that can be displayed on the display 32.

In either case, the area of the displaying region of the physiological information PI that is assigned to each subject is smaller than a case where the physiological information PI that is collected from a single subject is visualized on the screen 321 of the web browser. In this case, the sizes of the first region 3211, the second region 3212, the third region 3213, and the fourth region 3214 included in each displaying region, as well as the amount of information to be visualized are determined in accordance with the above-described rule.

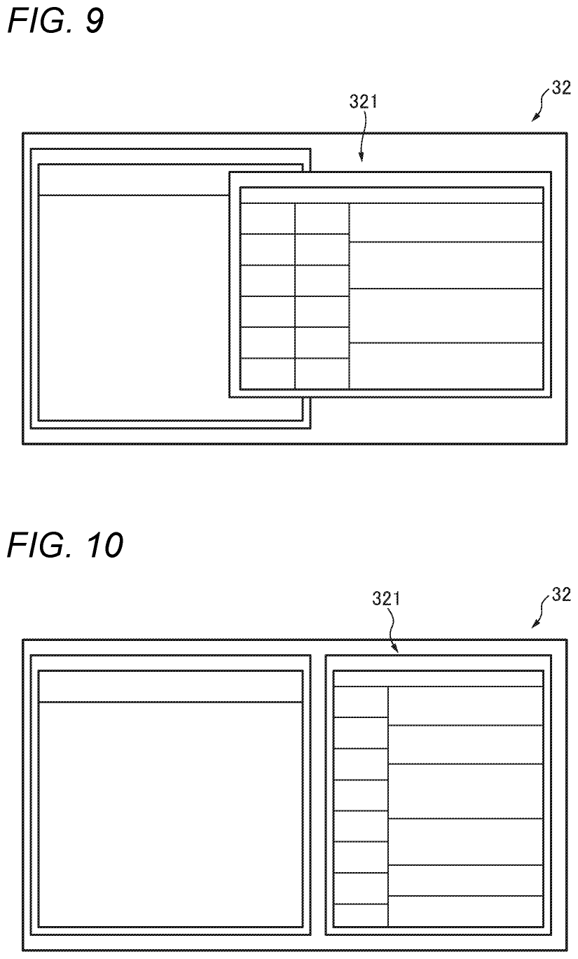

As illustrated in FIGS. 9 and 10, the position and size of the screen 321 of the web browser that is displayed on the display 32 of the terminal device 30 may change in accordance with the relationship with a screen of another application that is displayed at the same time. In either case, the sizes of the first region 3211, the second region 3212, the third region 3213, and the fourth region 3214 included in the screen 321, as well as the amount of information to be visualized are determined in accordance with the above-described rule.

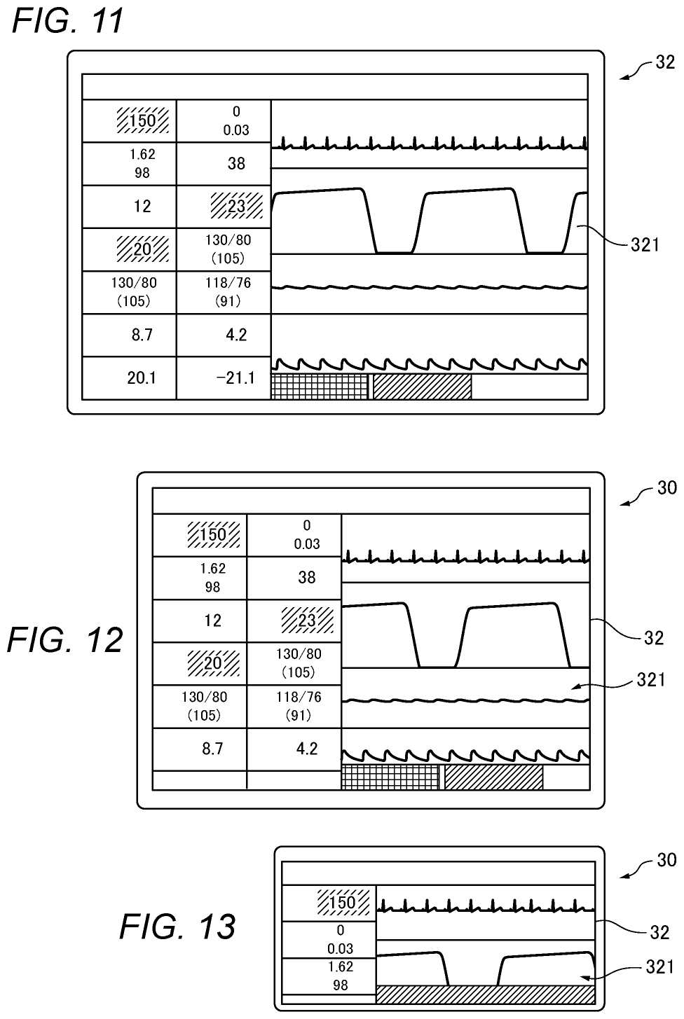

As illustrated in FIGS. 11 to 13, the size of the screen 321 of the web browser displayed on the display 32 of the terminal device 30 may depend on the size of the display 32. FIG. 11 illustrates an example in which a screen 321 is fully displayed on a stationary display device adapted to communicate with a terminal device 30 in the form of a desktop computer. FIG. 12 illustrates an example in which a screen 321 is fully displayed on a display 32 that is a part of a terminal device 30 in the form of a tablet terminal adapted to be carried by a user. FIG. 13 illustrates an example in which a screen 321 is fully displayed on a display 32 that is a part of a terminal device 30 in the form of a smartphone adapted to be carried by a user.

In either case, the sizes of the first region 3211, the second region 3212, the third region 3213, and the fourth region 3214 included in the screen 321, as well as the amount of information to be visualized are determined in accordance with the above-described rule.

The processor 31 of the terminal device 30 having various functions described above may be implemented by at least one non-exclusive microprocessor that cooperates with a non-exclusive memory. Examples of the non-exclusive microprocessor include a CPU, an MPU, and a GPU. Examples of the non-exclusive memory include a ROM and a RAM. In this case, a computer program that implements the various functions described above may be stored in the ROM. The ROM is an example of a non-transitory computer-readable medium having stored a computer program. The non-exclusive microprocessor designates at least a part of the program stored in the ROM, loads the designated program in the RAM, and executes the above-described processing in cooperation with the RAM.

The computer program may be pre-installed in a non-exclusive memory, or may be downloaded from an external server device with a communication network, and then installed in the non-exclusive memory. In this case, the external server device is an example of the non-transitory computer-readable medium having stored the computer program.

Alternatively, the computer program may be stored in a storage of the physiological information collecting device 20. In this case, the storage is an example of a non-transitory computer-readable medium having stored a computer program. The terminal device 30 can download the computer program from the physiological information collecting device 20 and install the downloaded computer program in the non-exclusive memory. According to such a configuration, the construction work of the physiological information observing system 10 can be facilitated.

The processor 31 may be implemented by at least one exclusive integrated circuitry capable of executing the above-described computer program, such as a microcontroller, an ASIC, and an FPGA. In this case, the above-described computer program is pre-installed in a memory element included in the exclusive integrated circuitry. The memory element is an example of the non-transitory computer-readable medium having stored the computer program. The processor 31 may also be implemented by a combination of the non-exclusive microprocessor and the exclusive integrated circuitry.

The various configurations described above are merely illustrative for facilitating understanding of the presently disclosed subject matter. Each of the illustrative configurations may be appropriately modified or combined with another illustrative configuration within the gist of the present disclosure.

In the above embodiment, the second region 3212 displayed on the screen 321 of the web browser is disposed on the left of the first region 3211. However, the second region 3212 may be disposed on the right of the first region 3211.

In the above embodiment, the physiological information collecting device 20 includes the display 23. However, as long as the physiological information PI that is collected by the physiological information collecting device 20 can be observed on the display 32 of the terminal device 30, the physiological information collecting device 20 may not include the display 23. In a case where the mobile terminal MT as the terminal device 30 is used, the physiological information PI may not be observed with the web browser. The physiological information PI may be observed with an adequate web application that uses a web API.

The physiological information PI may be observed with an application installed in the terminal device 30 or the mobile terminal MT so as to implement displaying function such as a desktop application and a mobile application. Examples of a communication protocol used with such an application may include, in addition to the HTTP, the WebSocket, and the web application exemplified above, User Data Protocol, Transmission Control Protocol, Quick UDP Internet Connections.

1. A physiological information collecting device, comprising:
a reception interface configured to receive physiological information of a subject;
a communication interface configured to allow communication with a terminal device provided with a display; and
a processor configured to create data for visualize information including at least the physiological information,
wherein the processor is configured to selectively execute either one of:
a first communication protocol configured to transmit the data from the communication interface as a reply to a request transmitted from the terminal device; and
a second communication protocol configured to transmit the data from the communication interface at a prescribed timing while maintaining connection established by a request transmitted from the terminal device; and
wherein information corresponding to the data transmitted by the second communication protocol has a higher priority for requiring an immediate display on the display than the information corresponding to the data transmitted by the first communication protocol.

2. The physiological information collecting device according to claim 1,
wherein the second communication protocol is a WebSocket protocol.

3. The physiological information collecting device according to claim 1, further comprising a display configured to visualize the physiological information based on the data.

4. A non-transitory computer-readable medium having stored a computer program adapted to be executed by a processor installed in a physiological information collecting device, the computer program being configured, when executed, to cause the physiological information collecting device to:
receive physiological information of a subject; and
create data for visualize information including at least the physiological information;
execute selectively either one of a first communication protocol or a second communication protocol;
wherein, in the first communication protocol, the data is transmitted as a reply to a request transmitted from the terminal device;
wherein, in the second communication protocol, the data is transmitted at a prescribed timing while maintaining connection established by a request transmitted from the terminal device; and
wherein information corresponding to the data transmitted by the second communication protocol has a higher priority for requiring an immediate display on the display than the information corresponding to the data transmitted by the first communication protocol.

5. A non-transitory computer-readable medium having stored a computer program adapted to be executed by a processor installed in a terminal device adapted to communicate with a physiological information collecting device configured to collect physiological information of a subject, the computer program being configured, when executed, to cause the terminal device to:
receive data corresponding to the physiological information; and
visualize, based on the data, at least a part of the physiological information on a screen of a web browser displayed on a display;
wherein the physiological information includes first information in which a display aspect ratio is fixed and second information in which the display aspect ratio is not fixed; and
wherein the terminal device is configured to change, based on an amount of the physiological information corresponding to the data and a size of the screen of the web browser, at least one of: a ratio of an area of a region in the screen of the web browser in which the first information is to be visualized and an area of a region in the screen of the web browser in which the second information is to be visualized; an amount of the first information to be visualized; and an amount of the second information to be visualized, while maintaining a scale of the display aspect ratio of the first information that is to be visualized.

6. The non-transitory computer-readable medium according to claim 5,
wherein the second information includes alarm information items whose priorities are different from each other;
wherein the terminal device is configured to determine an alarm information item to be visualized in the screen of the web browser, based on the priorities and the size of the screen of the web browser.

7. The non-transitory computer-readable medium according to claim 5,
wherein the computer program is enabled to be executed by the processor by being downloaded from the physiological information collecting device.

8. A terminal device adapted to communicate with a physiological information collecting device configured to collect physiological information of a subject, comprising:
a communication interface configured to receive data corresponding to the physiological information; and
a processor configured to visualize, based on the data, at least a part of the physiological information on a screen of a web browser displayed on a display,
wherein the physiological information includes first information in which a display aspect ratio is fixed and second information in which the display aspect ratio is not fixed; and
wherein the processor is configured to change, based on an amount of the physiological information corresponding to the data and a size of the screen of the web browser, at least one of: a ratio of an area of a region in the screen of the web browser in which the first information is to be visualized and an area of a region in the screen of the web browser in which the second information is to be visualized; an amount of the first information to be visualized; and an amount of the second information to be visualized, while maintaining a scale of the display aspect ratio of the first information that is to be visualized.

9. The terminal device according to claim 8, further comprising a display.

10. The terminal device according to claim 8, being adapted to be carried by a user.
